(19) United States
(12) Patent Application Publication
(10) Pub. No.: US 2015/0134153 A1
(43) Pub. Date: May 14, 2015

(54) SUPERVISION DEVICE FOR AN AIRCRAFT, ASSOCIATED SUPERVISION SYSTEM, SUPERVISION METHOD, COMPUTER PROGRAM PRODUCT AND NON-TRANSITORY COMPUTER READABLE MEDIUM

(71) Applicant: THALES, Neuilly Sur Seine (FR)

(72) Inventors: Francois Coulmeau, Seilh (FR); Arnaud Bonnafoux, Toulouse (FR); Nicolas Rossi, Toulouse (FR)

(21) Appl. No.: 14/540,725

(22) Filed: Nov. 13, 2014

(30) Foreign Application Priority Data
Nov. 14, 2013 (FR) FR1302615

(51) Int. Cl. G05D 1/00

(52) U.S. Cl. CPC G05D 1/00
USPC 701/3

(57) ABSTRACT

A supervision device for an aircraft including a plurality of avionics systems, each avionics system being able to generate parameters representative of its operation on a reference date, includes a plurality of prediction modules, each prediction module including a computer for computing projections representative of the trajectory of the aircraft and/or representative of the operation of at least one avionics system on a corresponding prediction date, the prediction date being after the reference date, at least one projection computed by a prediction module depending on at least one other projection computed by another prediction module.

This claims the benefit of French Patent Application FR 13 026 15, filed Nov. 14, 2013 and hereby incorporated by reference herein.

The present invention relates to a supervision device for an aircraft including a plurality of avionics systems, each avionics system being able to generate parameters representative of its operation on a reference date.

The invention also relates to a supervision system comprising such a supervision device and a plurality of avionics systems.

The invention also relates to a supervision method implemented by such a supervision device.

The invention also relates to a computer program product including software instructions which, when executed by a computer, carry out such a supervision method.

The invention also relates to a non-transitory computer readable medium comprising a computer program including software instructions which, when executed by a computer, carry out such a supervision method.

The invention relates to the field of the short-term prediction of the operational situation of an aircraft.

Within the meaning of the present invention, “short-term” refers to a time scale in the vicinity of several tens of seconds to several minutes.

“Operational situation” refers to data defining the status of the aircraft, its trajectory and its environment.

### BACKGROUND

French Patent Application No. 2,978,280 A1 describes a supervision device capable of analyzing parameters provided by onboard systems to generate alerts, for example to warn of the possibility of the occurrence of a breakdown, before it occurs. In general, these alerts are generated in the case where these parameters, or syntheses depending on these parameters, no longer meet predefined criteria, for example when the value of a parameter exceeds a predetermined threshold.

### SUMMARY OF THE INVENTION

Nevertheless, such a supervision device is not fully satisfactory. In fact, in that case, the alerts are triggered by predefined events and do not take the overall operational situation of the aircraft into account.

The crew is therefore required to assess these alerts in light of other information based on its experience, and to react accordingly. This causes a risk of incorrect decisions being made, in particular due to a lack of information and the complexity of their relations.

It is an object of the present invention to provide a supervision device able to provide, to a pilot or a piloting system of an aircraft, alerts relative to potential changes in the overall operational situation of the aircraft, with sufficient warning to allow the pilot or piloting system to react appropriately.

The present invention provides a supervision device of the aforementioned type, wherein the device includes a plurality of prediction modules, each prediction module comprising means for computing projections representative of the trajectory of the aircraft and/or representative of the operation of at least one avionics system on a corresponding prediction date, the prediction date being after the reference date, at least one projection computed by a prediction module depending on at least one other projection computed by another prediction module.

In fact, the projection(s) of a prediction module depending on the projection(s) of at least one other prediction module, the supervision device according to the invention merges information between various onboard avionics systems, in order to achieve a better short-term prediction of the overall operational situation of the aircraft.

According to other advantageous aspects of the invention, the supervision device may include one or more of the following characteristics, considered alone or according to any technically possible combinations:

at least one prediction module includes means for sending a projection computation request to another prediction module;

at least one prediction module includes means for receiving said requests and control means able to command the computation means to compute projections if a projection request is received;

at least one prediction module includes control means capable of commanding the computation means to compute projections in case of a variation in the value of the parameters and/or projections of the other modules on which the projections of said module depends;

the device includes control means able to command the computation means to compute projections after a predetermined latency duration;

the computation means are able to estimate the likelihood that the magnitude associated with a projection will assume, on a date after the reference date, the value calculated by the computation means for said projection on said date;

for at least one prediction module, the computation means are able to compute at least one projection on a prediction date, such that the likelihood that the magnitude associated with that projection will assume, on the prediction date, the value computed for said projection for said date, is equal to a predetermined target value;

for at least one prediction module, the computation means are able to compute projections on a prediction date such that a time shift between said reference date and the prediction date is equal to a second predetermined target value;

at least one prediction module is able to perform one function among trajectory prediction, aircraft system status prediction and aircraft performance prediction.

The invention also relates to a supervision system comprising a supervision device as defined above and a plurality of avionics systems.

According to another advantageous aspect of the invention, the supervision system may include the following feature:

the avionics systems include at least one element from the group consisting of: a flight management system, an automatic pilot, a taxi system, a monitoring system, a communication system, a centralized maintenance system, and an onboard systems monitoring system.

Furthermore, the invention relates to a supervision method implemented by a device as defined above, characterized in that it includes a step for computing projections representative of the trajectory of the aircraft and/or representative of the operation of at least one system on a corresponding prediction date, the prediction date being after the reference date, at least one projection computed by a prediction module depending on at least one other projection computed by another prediction module.

According to another advantageous aspect of the invention, the method further includes the following steps:

sending a request for the computation of at least one projection from a requesting prediction module to a responding prediction module;

receiving the requested projection(s) coming from the responding prediction module;

using the requesting prediction module to compute at least one projection based on the received projection(s).

Furthermore, the invention relates to a computer program product including software instructions which, when executed by a computer, carry out the method as defined above.

Furthermore, the invention relates to a non-transitory computer readable medium comprising a computer program including software instructions which, when executed by a computer, carry out the method as defined above.

### BRIEF DESCRIPTION OF THE DRAWINGS

The invention will be better understood using the following description, provided solely as a non-limiting example and done in reference to the appended drawings, in which:

FIG. 1 is a diagrammatic illustration of the supervision system including a supervision device according to the invention;

FIG. 2 is a diagrammatic illustration of a prediction module of the device of FIG. 1; and

FIG. 3 is a flowchart of a supervision method according to the invention.

### DETAILED DESCRIPTION

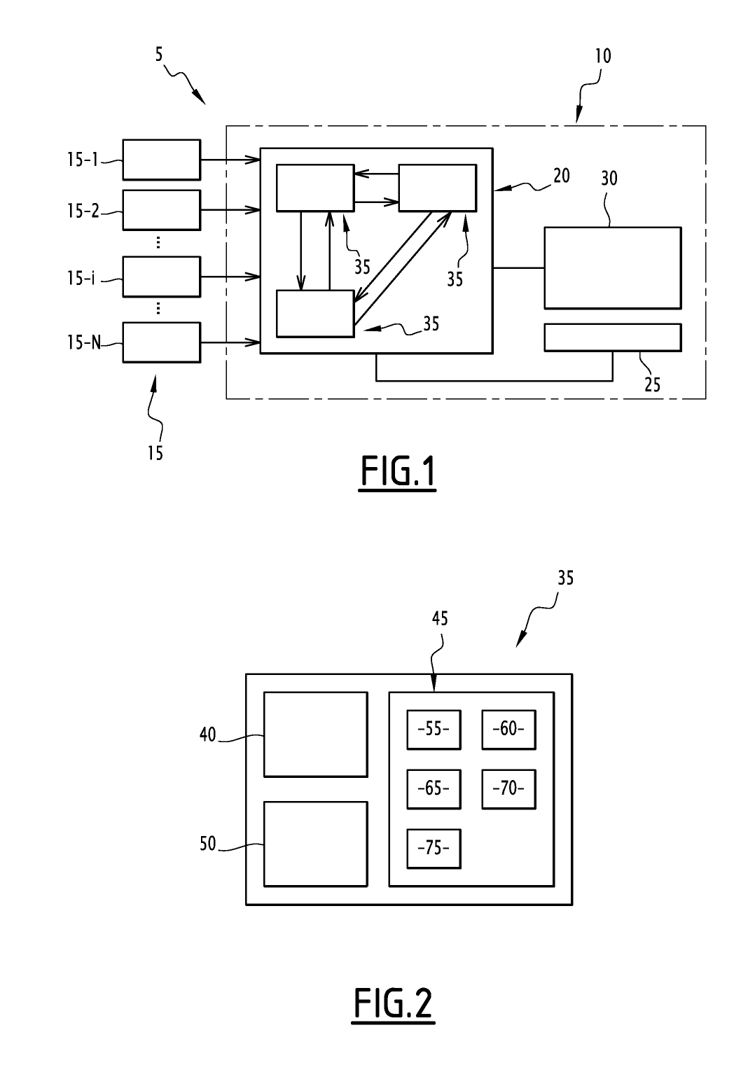

The supervision system 5 of FIG. 1 includes a supervision device 10 and a plurality of avionics systems 15 of the aircraft.

The supervision system 5 is capable of estimating the short-term operational situation of the aircraft.

The supervision device 10 is able to provide, to a pilot or a piloting system of the aircraft, an estimate of an operational situation of the aircraft on a prediction date after the reference dates Tref-i. The supervision device 10 is further suitable for generating alerts relative to potential short-term changes in the overall operational system of the aircraft, i.e., alerts relative to events that may occur on a date after the reference dates Tref-i.

The supervision device 10 includes a computation member 20, entry means 25 and display means 30.

The avionics systems 15 are respectively identified by references 15-1, 15-2, . . . , 15-i, . . . , 15-N.

The avionics systems 15-1, 15-2, . . . , 15-i, . . . , 15-N are able to generate parameters representative of their operation on a corresponding reference date, respectively Tref-1, . . . , Tref-i, . . . , Tref-N.

Preferably, each avionics system 15 of the supervision system 5 is an element from the group consisting of: a flight management system (FMS), an automatic pilot (AP), a taxi system (TAXI), a traffic collision avoidance system (TCAS), a terrain awareness and warning system (TAWS), a weather radar system (WXR), a communication system (DATALINK), a centralized maintenance system (CMS) and a built-in test equipment system (BITE).

The computation member 20 comprises a plurality of prediction modules 35.

The entry means 25 are connected at the input of the computation member 20.

The display means 30 are connected at the output of the computation member 20.

Each prediction module 35 is able to compute at least one projection P-1, P-2, . . . , P-k, . . . , P-M. The number of computed projections varies, and does not depend directly on the number of avionics systems 15 and the number of prediction modules 35.

For example, at least one prediction module 35 is able to compute a plurality of projections P-k each corresponding to one or more parameters.

For example, at least one prediction module 35 is able to compute a projection P-k with several prediction dates Tpred-k that are successive and after the reference dates Tref-i.

The entry means 25 are able to allow a user to select one or more projections to be displayed on the display means 30.

The display means 30 are capable of displaying data relative to the projections computed by the prediction modules 35 of the computation member 20, for example in the form of text, icons or lighted signals.

At least one prediction module 35 is able to perform one function from among trajectory prediction, status prediction of the avionics systems 15 of the aircraft and aircraft performance prediction.

“Trajectory prediction” refers to the computation of the position, speed-vector and orientation of the aircraft and their likelihood on a prediction date after the reference dates.

“System status prediction” refers to the computation of the availability, at one or more moments after the reference dates Tref-i, of a parameter generated by all or part of the avionics systems 15.

For example, for a static temperature probe, the status of that system corresponds to the availability of a reliable temperature measurement over a predetermined time interval after the reference date on which the static temperature probe provides a temperature measurement. The availability of the temperature measurement depends, for example, on the likelihood of icing or physical breakdown of the probe during that time interval.

According to another example, for a redundant positioning system such as a positioning system for an airplane, comprising inertial units, of which there are generally three, the status of that system corresponds to the quality of the consolidated datum from the data coming from the different redundant position computers. In the case of inertial units, the consolidated datum is the consolidated position of the airplane, computed from positions measured by the three units. If one of the inertial units has a drift that affects the position that it measures, that drift leading to a measured position located beyond a certain threshold, the other avionics systems using that position measurement enter so-called downgraded modes. In that case, the status of the system corresponds to the projection, on a prediction date after the reference dates, of the measurement of the position relative to the acceptable threshold, and the computation of the likelihood of occurrence of the projection of the position measurement on that prediction date.

“Prediction of the aircraft performance” refers to the prediction of the likelihood that the aircraft will behave according to the crew's expectations, on a prediction date after the reference dates.

For example, for the estimated consumption during a flight of the aircraft, the aircraft performance prediction corresponds to the deviation between the consumption measured on a reference date then projected to a prediction date after the reference date, and the consumption anticipated by the crew on the prediction date.

According to another example, for aircraft that will cross an area with disrupted weather, the travel capacity of the control surfaces is measured. The performance prediction corresponds to the projection, on a prediction date after the reference dates, of the deviation between the nominal travel and possible travel, relative to a threshold, and the computation of the likelihood of that the projection of that deviation will occur on the prediction date.

Each prediction module 35 is able to compute at least one projection from parameters coming from the avionics systems 15 and/or at least one projection computed by at least one other prediction module 35. According to the invention, at least one projection computed by a prediction module depends on at least one other projection computed by another prediction module.

For example, a projection P-k computed by one prediction module 35 is representative of the value of a parameter generated by an avionics system 15-i on a prediction date Tpred-k after the reference date Tref-i.

For example, a projection P-k computed by a prediction module 35 is representative of the operation of an avionics system 15 on a prediction date Tpred-k or representative of at least part of the operational situation of the aircraft on the prediction date Tpred-k, the prediction date Tpred-k being after the reference dates Tref-i of the parameters on which the projection P-k depends.

Furthermore, each prediction module 35 is able to estimate the reliability as a function of time of at least one computed projection P-k, on any date after the reference dates Tref-i associated with the parameters on which the projection P-k depends.

“Reliability” of a projection on a given date refers to the likelihood that a magnitude represented by said projection will, on that date, assume the value that the prediction module 35 corresponding to the projection computed for that projection, for that date.

Within the meaning of the present invention, “magnitude” refers to a variable for which a projection is computed, in other words a variable for which an estimation is computed.

Additionally, each prediction module 35 is able to compute a projection on a prediction date such that the reliability of the projection is equal to a first predetermined target value.

Additionally or alternatively, each prediction module 35 is able to compute a projection on a prediction date such that a time shift between the reference date of the projection and the prediction date is equal to a second predetermined target value.

The entry means 25 are also able to allow a user to enter first reliability target values or second time shift target values.

Each prediction module 35 is able to send a projection computation request to another prediction module 35 to request the computation and transmission of a projection.

For example, a prediction module 35 sends a request after a predetermined latency duration has elapsed since the most recent projection computation. The predetermined latency duration is for example chosen by a user and entered using the entry means 25.

Each prediction module 35 is able to receive requests and compute projections if a projection computation request is received.

Each prediction module 35 comprises a microprocessor 40, a memory 45 and a transceiver 50, the microprocessor 40 and the memory 45 forming an information processing unit.

The memory 45 is able to store software 55 for computing projections, software 60 for commanding the projection computation, software 65 for sending projection computation requests, software 70 for receiving projection computation requests and data sharing software 75.

The microprocessor 40 is able to load and execute each of the software applications 55, 60, 65, 70, 75.

The transceiver 50 is able to receive parameters coming from avionics systems 15, projections and requests coming from other prediction modules 35, first reliability target values or second time shift target values coming from the entry means 25.

The transceiver 50 is also able to send projections and projection computation requests to other prediction modules 35, and projections to the display means 30.

The computation software 55 is suitable for computing, once executed, projections based on parameters coming from the avionics systems 15 and/or at least one projection computed by at least one other prediction module 35.

The command software 60 is suitable for commanding the execution of the computation software 55 in order to compute projections of the prediction module 35, in the event a request is received at the end of the predetermined latency duration, or in the event of variations in the value of the parameters and/or projections of the other prediction modules 35 on which the projections of said module 35 depend.

The request-sending software 65 is suitable for sending projection computation requests to other modules 35 that are capable of computing the projections on which the projections of said module 35 depend.

The request-receiving software 70 is suitable for receiving projection computation requests from other modules 35 and communicating with the command software 60 upon receiving such requests.

The data sharing software 75 is suitable for receiving parameters of the avionics systems 15, sending projections to the prediction modules 35 having sent a projection computation request, and receiving projections from the prediction modules 35 to which a request has been sent.

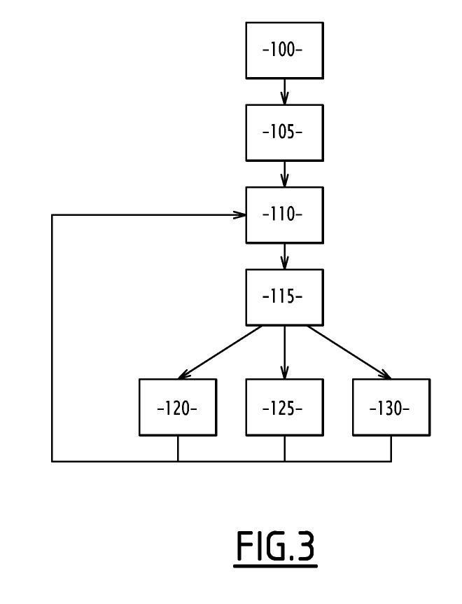

The operation of the supervision device 10 according to the invention will now be outlined, in reference to FIG. 3 showing a flowchart of a supervision method according to the invention.

During a first step 100 of the supervision method, each avionics system 15-i generates, on a corresponding reference date Tref-i, parameters representative of its operation.

The parameters generated by the avionics systems 15 are next sent to the corresponding prediction modules 35 of the computation member 20.

Each prediction module 35 computes at least one projection P-k representative of the operation of an avionics system 15 on a prediction date Tpred-k, or representative of at least part of the operational situation of the aircraft on the prediction date Tpred-k, the prediction date Tpred-k being after the reference dates Tref-i of the parameters on which the projection P-k depends.

During the following step 105, at least one prediction module 35, also called requesting module, sends a projection computation request to at least one other prediction module 35, also called responding module.

For example, the step 105 begins after a duration greater than or equal to the latency duration that has elapsed since the last projection computation by the requested module 35.

For example, step 105 begins when the reliability of a projection of the requesting module 35 for the corresponding prediction date becomes below the first predetermined target value.

During a following step 110, at least one prediction module 35 computes projections.

If the prediction module 35 in question has computed projections following reception of a projection computation request sent by a requesting prediction module 35, the corresponding responding prediction module 35 sends the computed projections to the corresponding requesting prediction module 35.

The requesting prediction module 35 receives the computed projections and computes projections based on the received computed projections.

During a following step 115, the computation member 20 sends the computed projections to the display means 30.

The display means 30 receive the computed projections and display data relative to the received computed projections.

During an event 120 after step 110, the value of the parameters from the avionics systems 15 and/or at least part of the projections computed by the first models 35 varies.

New values of the parameters and/or projections are sent to the second prediction modules 35, the projections of which depend on said parameters and/or said projections.

The second prediction modules 35 then once again compute projections according to step 110.

During an event 125 after step 110, a requesting prediction module 35 sends a new projection computation request to at least one responding prediction module 35.

The responding prediction module 35 receives the request and then once again computes projections according to step 110.

For example, the requesting prediction module 35 sends the request after the latency duration corresponding to said requesting module 35 has elapsed since the last projection computation.

For example, the requesting prediction module 35 sends the request when the reliability of a projection by the requesting module 35 for the corresponding prediction date becomes lower than the first predetermined target value.

During an event 130 after step 110, a user modifies the first predetermined target value for the reliability and/or the second predetermined target value for the time shift for a projection of a prediction module 35.

The corresponding new value is received by said prediction module 35.

The prediction module 35 then once again computes projections according to step 110 with the new value of the first target value or with the second target value.

Thus, the supervision device 10 according to the invention can provide a short-term prediction of the overall operational situation of the aircraft, because it is able to combine projections relative to the status of interdependent avionics systems 15.

The intercommunication of the prediction modules 35, based on the transmission and reception of projection computation requests, allows autonomous operation of the supervision device, while ensuring better short-term prediction than in the supervision device of the state of the art, where only the parameters of the avionics systems 15 are taken into account to compute projections.

From the user's perspective, the availability of the reliability of a projection, and the possibility of setting a prediction date based on a target reliability value of the projection, makes it possible to pilot the aircraft with a reduced number of false alerts.

Furthermore, the possibility of setting the time shift between a reference date and a prediction date provides the user with a view of the short term effectiveness of the prediction of the overall operational situation of the aircraft.

One can then see that the supervision device 10 according to the invention makes it possible to provide a pilot or a piloting system of the aircraft with alerts relative to potential changes in the overall operational situation of the aircraft, with sufficient notice to allow the pilot or the piloting system to react appropriately.

As an illustration and additionally, an example relative to the availability of the static air temperature (SAT) measurement is provided below. The static air temperature corresponds to the temperature of the air near the aircraft, in an area of the atmosphere not disrupted by said aircraft.

During operation of the aircraft, a temperature sensor, generally a resistive sensor positioned in a Pitot tube, takes a measurement of the impact temperature T. The impact temperature is equal to the total air temperature (TAT) that has been corrected with the heating due to potential deployment of the deicing function of the sensor. The total air temperature TAT is the temperature of the air moving around the aircraft and is obtained using the equation:

$$\begin{matrix}TAT = \frac{{T}_{i}}{1 + 0.2 \text{?} M} & ( 1 ) \\ \text{?} \text{indicates text missing or illegible when filed} & \end{matrix}$$

where M is the Mach number.

The static air temperature SAT is obtained using the equation:

$$SAT = {T}_{i} * {( 1 + \frac{{P}_{t} {P}_{s}}{{P}_{s}} )}^{0.28} \qquad ( 2 )$$

where Pₜ is the measured value of the total pressure and Pₛ is the measured value of the static pressure.

The impact temperature sensor, the static and total pressure measurement sensors, each have a reliability that is related to the measuring errors and failure likelihood of its component elements. These reliabilities depend on internal physical characteristics of the sensors (electronics, resistances, etc.) and the environment (humidity, icing, outside air temperature, etc.). Knowing these reliabilities makes it possible to determine the likelihood of a failure of the static air temperature SAT measurement, the likelihood of failure being related to the propagation of measurement failures relative to the impact temperature Ti, the static pressure Pₛ and the total pressure Pₜ.

According to another example, for the estimated position of the aircraft during flight, the prediction of the performance levels corresponds to the deviation between the projected position, i.e., estimated on a prediction date after a reference date from the position measured from the reference date, and the position anticipated by the crew on the prediction date.

For example, for an aircraft moving vertically, the vertical evolution of a fixed-wing aircraft follows the dynamic equation below:

$$\begin{matrix}\sum {\overline{F}}_{ext} = m \cdot \frac{d \text{?}}{d \text{?}} & ( 3 ) \\ \text{?} \text{indicates text missing or illegible when filed} & \end{matrix}$$

If equation (3) is broken down into horizontal and vertical axes, we obtain equation

$$m \cdot \frac{d V}{d t} = Tx - Fx - m \cdot g \cdot sin γ \qquad ( 4 )$$

on the horizontal axis

Fz=m·g·cos γ (5)

on the vertical axis

where m is the mass of the aircraft, V is its ground speed, Tx is its thrust, Fx is its drag, γ is the aerodynamic slope and Fz is the lift force.

Traditionally, the lift force Fz is expressed using the following equation:

Fz=½ρ·S·V²·Cz (6)

where ρ is the air density, S is the aerodynamic surface and Cz is the lift coefficient.

Traditionally, the drag Fx is expressed according to the equation:

Fx=½ρ·S·V²·Cx (7)

where Cx is the drag coefficient.

Traditionally, the lift Cz and drag Cx coefficients are connected by a so-called “polar aerodynamic” equation:

Cz=f(Cz) (8)

In order to compute the drag coefficient Cx, it is known to use a table, a polynomial or a function resulting from numerical computations and wind tunnel tests.

It is then possible to determine the ground speed V and the aerodynamic slope γ.

By successive integrations of equations (4) and (5), the airplane positions x and z are obtained using the following equation:

$$\frac{d x}{d t} = V \cdot cos γ , \frac{d z}{d t} = V \cdot sin γ \qquad ( 9 )$$

The drag coefficient Cx for example verifies the equation:

Cx−f(Cx_lisse,Cx_(i),Cx_{—}m) (10)

where Cx_lisse is the value of the drag in the smooth configuration (i.e., when the air brakes, leading edge slats, flaps and gear are in), Cx_m is the drag caused by the airplane mass, and Cx_conf(i) is the value of the additional journey corresponding to a configuration with index i among Nconf possible configurations. In each configuration, elements from among the leading edge slats, the flaps, the gear and the air brakes are deployed. The index i takes all positive integer values between 1 and Nconf into account, Nconf being greater than or equal to 2.

The function f is generally a simple weighted sum between the different coefficients Cx_lisse, Cx_m and Cx_conf(i).

Furthermore, different control modes of the airplane exist in the lateral plane: heading hold (Heading), track hold (Track), trajectory tracking (LNAV).

Different “control modes” for the airplane thus exist in the vertical flight plane:

imposed fixed thrust and speed mode;

imposed fixed slope and speed mode;

imposed fixed slope and thrust mode; or

imposed fixed thrust and acceleration/deceleration mode.

Thus, the error relative to the future position of the aircraft is quantified by incorporating the aforementioned equations (4), (5) along passage points (given by the latitude and longitude), said passage points optionally being associated with constraints (altitude, speed, time), and taking into account the uncertainties for example related to the computation of the current position, modeling errors in the flight management system of the aircraft, simplifications relative to the actual aerodynamics of the aircraft that have been introduced into the tables of the flight management system, or errors between the onboard digital weather model and the actual weather.

One example relative to the reliability of the position projection is provided below.

The computation of said reliability for example passes through knowledge of the instantaneous performance and a statistical propagation model of the airplane navigation, i.e., a model associated with the noises on the propagation model of the airplane trajectory.

For example, knowing the performance levels for each of the axes (longitudinal, lateral and vertical) of sensors able to determine the location of the aircraft, a chain for building the reference trajectory and a guide chain, three matrices are built:

a first matrix comprising vectors EB_loc, EB_traj, EB_guid, which are vectors of the errors in the estimate of the localization, trajectory and guide biases, respectively;

a second matrix comprising vectors ED_loc, ED_traj, ED_guid, which are vectors of the errors in the estimate of the localization, trajectory and guide drifts, respectively;

a third matrix comprising vectors S_loc, S_traj, S_guid, which are vectors of the standard deviations of the noises estimated on the localization, trajectory and guiding, respectively.

In general, such matrices have coefficients that translate the influence, on a second axis, of the error committed on a first axis.

If, for example, we consider these 3 errors to be independent of one another and we consider the distributions to be Gaussian, it is possible to deduce the total error vector X % (95%, 99%, 99.9%) that is likely on a date T0+dT, where T0 is the current date:

E(T0+dT)=(E_longi,E_lat,E_vert)T

E(T0+dT)=E(T0)+EB_loc+EB_traj+EB_guid+ED*(dT dT dT)T+N*(S_loc+S_traj_{—}+S_Guid)

where E(T0) is the total error estimated on the current date T0.

This approach also works with other models of the statistical error distribution.

With such an approach, one computes, at any moment T0, the likelihood that the aircraft will be located outside a monitored zone on a subsequent date T0+dT, dT being the time drift between the current date and the subsequent date.

With such a propagation computation, the navigation and guidance performance is also computed that is expected on the later date T0+dT, in terms of value at 95% or 99.99%, for example.

The value of the time deviation dT provides the time depth chosen in the preceding step. The confidence values (95% and 99.99% above) may also for example be chosen to determine the value of the time deviation dT corresponding to such a confidence value.

What is claimed is:

1. A supervision device for an aircraft having a plurality of avionics systems, each avionics system being configured to generate parameters representative of a respective operation on a reference date, the supervision device comprising:
a plurality of prediction modules, each prediction module comprising a computer for computing projections representative of a trajectory of the aircraft or representative of the respective operation of at least one of the plurality avionics systems on a corresponding prediction date, the prediction date being after the reference date,
at least one projection computed by one of the plurality of prediction modules depending on at least one other projection computed by another prediction module of the plurality of prediction modules,
the one prediction module including a controller capable of commanding the respective computer to compute the at least one projection in case of a variation in the value of the parameters or the at least one other projection of the other prediction module on which the projection of the one prediction module depends.

2. The device as recited in claim 1 wherein the other prediction module includes a transmitter for sending a projection computation request to the one prediction module.

3. The device as recited in claim 2 wherein the one prediction module includes a receiver for receiving the projection computation request and the controller is configured to command the respective computer to compute projections if the projection computation request is received.

4. The device as recited in claim 1 wherein the controller or a further controller is configured to command the computer to compute the projection after a predetermined latency duration.

5. The device as recited in claim 1 wherein the computer is configured to estimate the likelihood that a magnitude associated with the projection will assume, on a date after the reference date, a value calculated by the computer for the projection on said date.

6. The device as recited in claim 5 wherein for the at least one prediction module, the computer is configured to compute the at least one projection on a prediction date such that the likelihood that the magnitude associated with said projection will assume, on the prediction date, the value computed for said projection for said date, is equal to a predetermined target value.

7. The device as recited in claim 5 wherein for the at least one prediction module, the computer is configured to compute the projection on the prediction date such that a time shift between said reference date and the prediction date is equal to a second predetermined target value.

8. The device as recited in claim 6 wherein for the at least one prediction module, the computer is configured to compute the projection on the prediction date such that a time shift between said reference date and the prediction date is equal to a second predetermined target value.

9. The device as recited in claim 1 wherein the at least one prediction module is configured to perform one function from among trajectory prediction, status prediction of the systems of the aircraft and aircraft performance prediction, the performance prediction corresponding to the computation of a deviation between a magnitude relative to the aircraft and a predetermined reference value.

10. The device as recited in claim 9 wherein the magnitude relative to the aircraft is consumption or control surface travel.

11. A supervision system comprising the supervision device as recited in claim 1 and the plurality of avionics systems.

12. The system as recited in claim 11 wherein the avionics systems include at least one element from the group consisting of: a flight management system, an automatic pilot, a taxi system, a monitoring system, a communication system, a centralized maintenance system, and a built-in test equipment.

13. A supervision method implemented by the device as recited in claim 1, the method comprising:
a computation step for computing projections representative of a trajectory of the aircraft or representative of a respective operation of at least one system on a corresponding prediction date, the prediction date being after the reference date,
at least one projection computed by a prediction module depending on at least one other projection computed by another prediction module.

14. The method as recited in claim 13 further comprising the following steps:
sending a request for the computation of the at least one projection from a requesting prediction module to a responding prediction module;
receiving the requested projection coming from the responding prediction module; and
using the requesting prediction module to compute at least one projection based on the received projection.

15. A computer program product comprising software instructions which, when executed by a computer, implement the method as recited in claim 13.

16. A non-transitory computer readable medium comprising a computer program including software instructions which, when executed by a computer, implement the method as recited in claim 13.
